(19) United States
(12) Patent Application Publication
(10) Pub. No.: US 2025/0055148 A1
(43) Pub. Date: Feb. 13, 2025

(54) Flexible Busbar Having Cover Member Capable of Preventing Corrosion and Battery Module Including the Same

(71) Applicant: LG Energy Solution, Ltd., Seoul (KR)

(72) Inventor: Sang Ok Seon, Daejeon (KR)

(73) Assignee: LG Energy Solution, Ltd., Seoul (KR)

(21) Appl. No.: 18/286,170

(22) PCT Filed: Mar. 9, 2023
(86) PCT No.: PCT/KR2023/003244

§ 371 Date: Oct. 9, 2023

(30) Foreign Application Priority Data
May 19, 2022 (KR) 10-2022-0061326

(51) Int. Cl. H01M 50/505; H01M 50/276; H01M 50/517; H01M 50/526

(52) U.S. Cl. CPC H01M 50/505; H01M 50/276; H01M 50/517; H01M 50/526

(57) ABSTRACT

The present invention relates to a flexible busbar having a cover member capable of preventing corrosion and a battery module including the same, and more particularly a flexible busbar including a busbar body having a structure in which metal sheets each having a predetermined width, thickness, and length are stacked, the busbar body being provided in each of opposite ends thereof in a longitudinal direction thereof with first through-holes each configured to allow a fastening member to be inserted therethrough, a first cover member configured to cover a middle part of the busbar body, and a second cover member configured to cover each of the opposite ends of the busbar body.

### CROSS-REFERENCE TO RELATED APPLICATIONS

This application is a national phase entry under 35 U.S.C. § 371 of International Application No. PCT/KR2023/003244, filed Mar. 9, 2023, which claims the benefit of priority to Korean Patent Application No. 10-2022-0061326 filed on May 19, 2022, the disclosure of which is incorporated herein by reference in its entirety.

### TECHNICAL FIELD

The present invention relates to a flexible busbar having a cover member capable of preventing corrosion and a battery module including the same, and more particularly to a flexible busbar having a cover member capable of preventing corrosion that may occur as the result of a metal busbar body constituting the flexible busbar being exposed to a salt damage environment and a battery module including the same.

### BACKGROUND ART

With recent development of alternative energies due to air pollution and energy depletion caused as the result of use of fossil fuels, demand for secondary batteries capable of storing electrical energy that is produced has increased. The secondary batteries, which are capable of being charged and discharged, are intimately used in daily life. For example, the secondary batteries are used in mobile devices, electric vehicles, and hybrid electric vehicles.

Required capacities of secondary batteries used as energy sources of various kinds of electronic devices inevitably used in modern society have been increased due to an increase in usage of mobile devices, increasing complexity of the mobile devices, and development of electric vehicles.

For example, in a vehicle, an energy storage system, etc., a plurality of battery modules or battery packs is connected to each other in series or in parallel in order to increase the capacity and output thereof. In general, the battery modules or the battery packs are electrically connected to each other via a busbar.

The busbar may be classified as a rigid busbar or a flexible busbar. The flexible busbar is mainly used to connect various kinds of electronic devices to each other in addition to series or parallel connection between battery modules or battery packs. In particular, the flexible busbar is used on a complicated route having a narrow or bent space.

Meanwhile, in an energy storage system, a wind power plant, or a tidal power plant installed near the waterfront, a secondary battery is used in order to store or supply produced electricity. However, air near the waterfront contains a large amount of salt. If the busbar is exposed to such air, the busbar may become corroded, which may lead to a major accident.

FIG. 1 is a perspective view showing a conventional flexible busbar. As shown in FIG. 1, the conventional flexible busbar, which is constituted by stacked flat conductors, includes a conduction portion 10, a first terminal portion 20 located at one side of the conduction portion 10, a second terminal portion 30 located at the other side of the conduction portion 10, and a tube member 40 configured to wrap the conduction portion 10.

Since the conventional flexible busbar can be curved or bent, cable connection in a narrow space is easily achieved.

Since the first terminal portion 20 and the second terminal portion 30 are exposed to air, however, the terminal portions may be corroded at the time of contacting sea breeze or salt water.

### PRIOR ART DOCUMENT

(Patent Document 1) Korean Patent Application Publication No. 2020-0116880

### Technical Problem

The present invention has been made in view of the above problems, and it is an object of the present invention to provide a flexible busbar configured not to be corroded even in a potential salt-damaging environment and a battery module including the same.

### Technical Solution

In order to accomplish the above object, a flexible busbar having a cover member capable of preventing corrosion according to the present invention includes a busbar body (100) having a structure in which metal sheets each having a predetermined width, thickness, and length are stacked, the busbar body being provided in each of opposite ends thereof in a longitudinal direction thereof with a first through-hole (110) configured to allow a fastening member (B) to be inserted therethrough, a first cover member (200) configured to wrap a middle part of the busbar body (100), and a second cover member (300) configured to wrap each of the opposite ends of the busbar body (100).

Also, in the flexible busbar according to the present invention, the metal sheets may include a copper sheet and an aluminum sheet.

Also, in the flexible busbar according to the present invention, the first cover member (200) may be made of an insulative material.

Also, in the flexible busbar according to the present invention, the insulative material may be at least one of an epoxy resin and a polyester resin, which are thermosetting resins.

Also, in the flexible busbar according to the present invention, the second cover member (300) may be made of rubber or silicone.

Also, in the flexible busbar according to the present invention, the second cover member (300) may be provided with a second through-hole (310) configured to allow the fastening member (B) to be inserted therethrough.

Also, in the flexible busbar according to the present invention, the second cover member (300) may be located at an upper surface, a side surface, a front surface, and a rear surface of the busbar body (100) in tight contact therewith.

Also, in the flexible busbar according to the present invention, the second through-hole (310) may have an inner diameter equal to or greater than the outer diameter of a head of the fastening member (B).

Also, in the flexible busbar according to the present invention, the first cover member (200) and the second cover member (300) may be located such that a part of the first cover member and a part of the second cover member overlap each other.

Also, in the flexible busbar according to the present invention, the second cover member (300) may be a metal film layer.

Also, in the flexible busbar according to the present invention, the metal film layer may be made of at least one of silver, tin, and nickel.

In addition, the present invention provides a battery module including the flexible busbar having the above features.

### Advantageous Effects

As is apparent from the above description, a flexible busbar according to the present invention has an advantage in that a first cover member is mounted to the middle of a busbar body constituted by metal sheets and a second cover member is provided at each of opposite ends of the busbar body, whereby corrosion of the flexible busbar is reduced or prevented even in a potential salt-damaging environment.

### DESCRIPTION OF DRAWINGS

FIG. 1 is a perspective view showing a conventional flexible busbar.

FIG. 2 is a perspective view of a flexible busbar according to a first preferred embodiment of the present invention.

FIG. 3 is a plan view of the flexible busbar according to the first preferred embodiment of the present invention.

FIG. 4 is a sectional view showing the state in which a fastening member is coupled to the flexible busbar, taken along line A-A′ of FIG. 2.

FIG. 5 is a view illustrating a process of manufacturing the flexible busbar according to the first preferred embodiment of the present invention.

FIG. 6 is a perspective view of a flexible busbar according to a second preferred embodiment of the present invention.

FIG. 7 is a plan view of the flexible busbar according to the second preferred embodiment of the present invention.

FIG. 8 is a sectional view showing the state in which a fastening member is coupled to the flexible busbar, taken along line A-A′ of FIG. 6.

FIG. 9 is a perspective view of a second cover member according to a second preferred embodiment of the present invention.

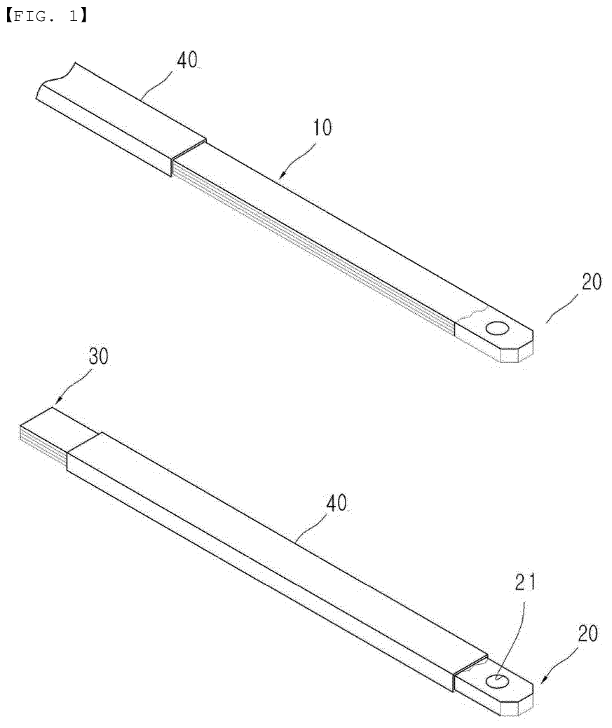

### BEST MODE

Now, preferred embodiments of the present invention will be described in detail with reference to the accompanying drawings such that the preferred embodiments of the present invention can be easily implemented by a person having ordinary skill in the art to which the present invention pertains. In describing the principle of operation of the preferred embodiments of the present invention in detail, however, a detailed description of known functions and configurations incorporated herein will be omitted when the same may obscure the subject matter of the present invention.

In addition, the same reference numbers will be used throughout the drawings to refer to parts that perform similar functions or operations. In the case in which one part is said to be connected to another part throughout the specification, not only may the one part be directly connected to the other part, but also, the one part may be indirectly connected to the other part via a further part. In addition, that a certain element is included does not mean that other elements are excluded, but means that such elements may be further included unless mentioned otherwise.

Hereinafter, a flexible busbar having a cover member capable of preventing corrosion according to the present invention and a battery module including the same will be described with reference to the accompanying drawings.

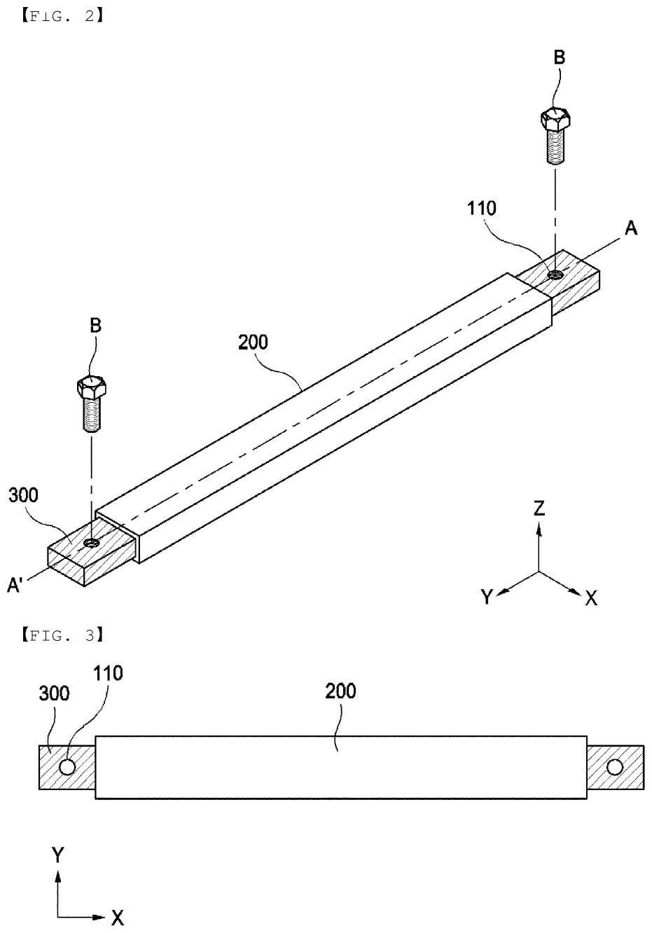

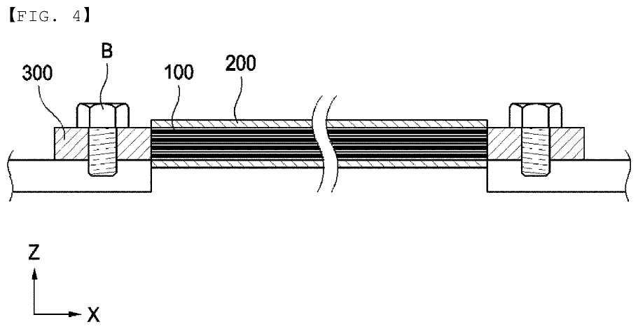

FIG. 2 is a perspective view of a flexible busbar according to a first preferred embodiment of the present invention, FIG. 3 is a plan view of the flexible busbar according to the first preferred embodiment of the present invention, and FIG. 4 is a sectional view showing the state in which a fastening member is coupled to the flexible busbar, taken along line A-A′ of FIG. 2.

As shown in FIGS. 2 to 4, the flexible busbar according to the present invention includes a busbar body 100, a first cover member 200, and a second cover member 300.

First, the busbar body 100 has a structure in which metal sheets each having a predetermined width, thickness, and length are stacked, and a first through-hole 110 is formed in the vicinity of (e.g., proximate to) the edge of each of opposite ends of the busbar body in a longitudinal direction thereof.

Here, the metal sheets each having the predetermined width, thickness, and length are copper sheets and aluminum sheets, which are alternately stacked. The copper sheets are located at the uppermost side and the lowermost side, and the aluminum sheet is located in the middle.

Of course, a plurality of stacks, each of which is constituted by a copper sheet, an aluminum sheet, and a copper sheet stacked from above, may be stacked. In addition, a copper sheet, an aluminum sheet, a copper sheet, an aluminum sheet, and a copper sheet may be stacked in that order.

The first through-hole 110 may be formed in the vicinity of (or proximate to) the edge of each of opposite ends of the busbar body 100 in the longitudinal direction thereof (Y-axis direction). A fastening member B is inserted through the first through-hole 110 in order to fix the busbar body 100 to a target to be connected.

Here, the fastening member B may be a bolt constituted by a cylindrical screw portion having a screw thread formed thereon and a head portion having a larger diameter than the screw portion.

The first cover member 200 is located at a middle part of the busbar body excluding the edges of the opposite ends thereof where the first through-hole 110 is formed. The first cover member is configured to prevent electrical conduction to a nearby metal material and to prevent attachment of external foreign matter to the busbar body 100.

The first cover member 200 may be formed in the shape of a hollow tube so as to be mounted to the busbar by fitting. Alternatively, the first cover member may be formed by coating.

The material for the first cover member 200 is not particularly restricted as long as the first cover member is capable of performing the above function. As an example, at least one of an epoxy resin and a polyester resin, which are thermosetting resins, may be used.

The second cover member 300 is located at the edge of each of the opposite ends of the busbar body 100 where the first through-hole 110 is formed, and the second cover member may be a metal film layer formed by plating.

The second cover member 300 is configured to prevent corrosion at the edge of each of the opposite ends of the busbar body 100. As described above, there are scenarios in which the flexible busbar may be exposed to air containing salt depending on the environment in which the flexible busbar is used, and it may cause any aluminum constituting the busbar body 100 to become corroded. The second cover member 300, however, prevents exposure of aluminum to the outside ambient air, thereby inhibiting corrosion.

Here, the metal film layer may be made of at least one of silver, tin, and nickel; however, the material of the metal film layer is not limited thereto as long as the metal film layer covers the edge of each of the opposite ends of the busbar body 100, thereby preventing exposure of the edge of each of the opposite ends of the busbar body from an external environment and the metal film layer is made of a material that allows current to flow therethrough.

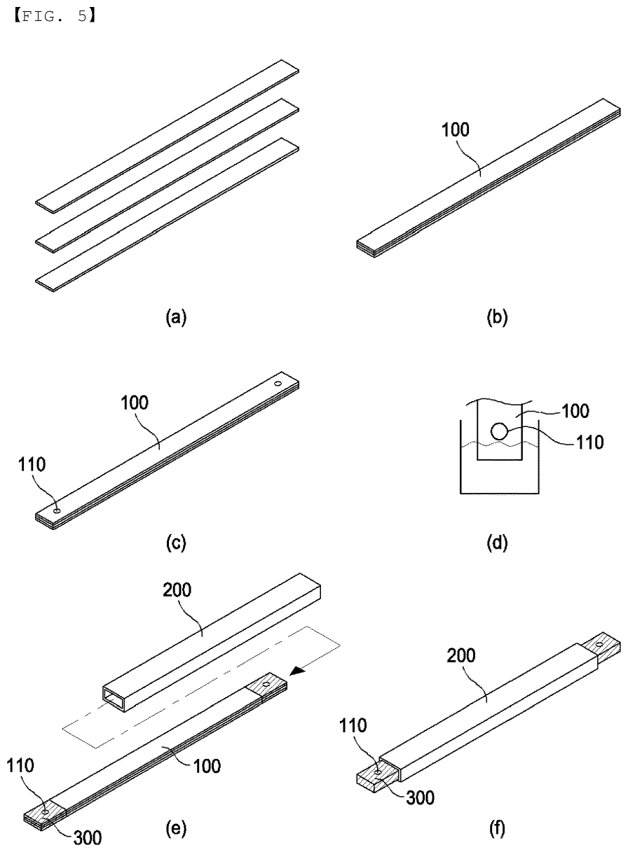

FIG. 5 is a view illustrating a process of manufacturing the flexible busbar according to the first preferred embodiment of the present invention.

Referring to FIG. 5, the process of manufacturing the flexible busbar includes a step of preparing a plurality of metal sheets constituted by a copper sheet and an aluminum sheet ((a) of FIG. 5), a step of stacking the plurality of metal sheets to form one stack ((b) of FIG. 5), a step of forming a first through-hole 110 in the vicinity of the edge of each of opposite ends of the prepared stack to prepare a busbar body 100 ((c) of FIG. 5), a step of soaking the opposite ends of the busbar body 100 in a plating solution to form a second cover member 300, which is a metal film layer ((d) of FIG. 5), and a step of coupling a first insulative cover member 200 to a middle part of the busbar body 100 ((e) of FIG. 5). (f) of FIG. 5 shows a flexible bus bar manufactured through the above-described process.

Meanwhile, it is preferable for a part of the first cover member 200 and a part of the second cover member 300 to overlap each other in order to surely prevent exposure of the aluminum sheet of the busbar body to the outside ambient air.

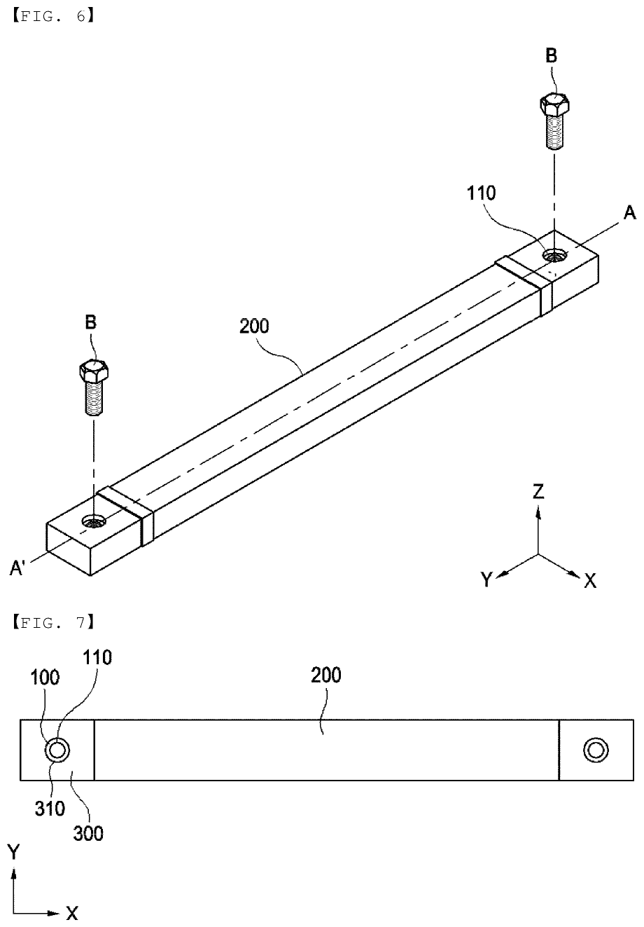

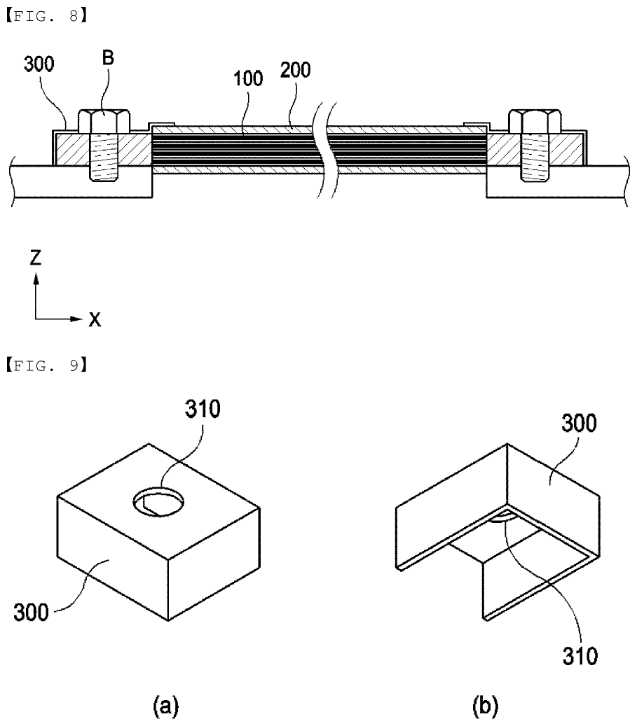

FIG. 6 is a perspective view of a flexible busbar according to a second embodiment of the present invention, FIG. 7 is a plan view of the flexible busbar according to the second embodiment of the present invention, and FIG. 8 is a sectional view showing the state in which a fastening member is coupled to the flexible busbar, taken along line A-A′ of FIG. 6.

Referring to FIGS. 6 to 8, the flexible busbar according to the second embodiment of the present invention is identical in construction to the flexible busbar according to the first embodiment of the present invention described with reference to FIGS. 2 to 4 except for a second cover member 300, and therefore a description of the same construction shared in common will be omitted.

In the flexible busbar according to the second embodiment of the present invention, the second cover member 300 is made of an insulative material and is located so as to wrap each of opposite ends of a busbar body 100.

Here, it is preferable for the insulative material to be rubber or silicone. In this case, there is an advantage in that manufacturing cost may be lower than in the first embodiment in which the second cover member is made of a metal material, such as tin or nickel.

The second cover member 300 is located at each of the opposite ends of the busbar body 100. It is preferable for one edge (e.g., an inner edge) of the second cover member 300 to extend to a part of one edge (e.g., an outer edge) of a first cover member 200 such that a part of the first cover member 200 and a part of the second cover member 300 overlap each other.

Here, the second cover member 300 may be fixed to each of the opposite ends of the busbar body 100 by fitting. Alternatively, the second cover member 300 may be securely fixed to each of the opposite ends of the busbar body 100 using a known adhesive having a high flash point.

FIG. 9 is a perspective view of a second cover member according to a second preferred embodiment of the present invention. Referring to FIGS. 6 and 9, the second cover member 300 according to the second embodiment may be formed in a shape that wraps an upper surface (Z-axis direction), a side surface (Y-axis direction), a front surface (X-axis direction), and a rear surface (X-axis direction) of each of the opposite ends of the busbar body 100. That is, a lower surface (Z-axis direction) of each of the opposite ends of the busbar body 100 is open.

In other words, the lower surface (Z-axis direction), at which a target to be electrically connected to the flexible bar is located, is open.

Meanwhile, a second through-hole 310, through which a fastening member B is inserted, is formed in the second cover member 300. The inner diameter of the second through-hole 310 may be equal to or greater than the outer diameter of a head of the fastening member B.

Of course, it is preferable for the second through-hole 310 formed in the second cover member 300 to be located on the same vertical line as the first through-hole 110 of the busbar body 100 such that the fastening member B is inserted through the first through-hole of the busbar body.

In addition, the present invention may provide a battery module including the flexible busbar.

Those skilled in the art to which the present invention pertains will appreciate that various applications and modifications are possible within the category of the present invention based on the above description.

### DESCRIPTION OF REFERENCE SYMBOLS

100: Busbar body
110: First through-hole
200: First cover member
300: Second cover member
310: Second through-hole
B: Fastening member

1. A flexible busbar comprising:
a busbar body having a structure in which a plurality of sheets each having a predetermined width, thickness, and length are stacked, the busbar body defining first through-holes in each of opposite ends in a longitudinal direction thereof, each through-hole configured to allow a fastening member to be inserted therethrough;
a first cover member configured to cover a middle part of the busbar body; and
a second cover member configured to cover each of the opposite ends of the busbar body.

2. The flexible busbar according to claim 1, wherein the plurality of sheets comprise a copper sheet and an aluminum sheet.

3. The flexible busbar according to claim 2, wherein the first cover member is made of an insulative material.

4. The flexible busbar according to claim 3, wherein the insulative material is at least one of an epoxy resin and a polyester resin, which are thermosetting resins.

5. The flexible busbar according to claim 2, wherein the second cover member is made of rubber or silicone.

6. The flexible busbar according to claim 5, wherein the second cover member defines a second through-hole configured to allow the fastening member to be inserted therethrough.

7. The flexible busbar according to claim 5, wherein the second cover member is disposed on an upper surface, a side surface, a front surface, and a rear surface of the busbar body and in contact with each surface.

8. The flexible busbar according to claim 6, wherein the second through-hole has an inner diameter equal to or greater than an outer diameter of a head of the fastening member.

9. The flexible busbar according to claim 5, wherein the first cover member and the second cover member are positioned such that a portion of the first cover member and a portion of the second cover member overlap each other.

10. The flexible busbar according to claim 2, wherein the second cover member is a metal film layer.

11. The flexible busbar according to claim 10, wherein the metal film layer is made of at least one of silver, tin, and nickel.

12. A battery module comprising the flexible busbar according to claim 1.
